(19) United States
(12) Patent Application Publication
(10) Pub. No.: US 2016/0023873 A1
(43) Pub. Date: Jan. 28, 2016

(54) PRY BAR

(71) Applicant: Eli Kasan, Pittsburgh, PA (US)

(72) Inventor: Eli Kasan, Pittsburgh, PA (US)

(21) Appl. No.: 14/804,498

(22) Filed: Jul. 21, 2015

Related U.S. Application Data
(60) Provisional application No. 62/027,530, filed on Jul. 22, 2014.

(51) Int. Cl. B66F 15/00

(52) U.S. Cl. CPC B66F 15/00

(57) ABSTRACT

Pry bars that will not slip off a lower support structure (such as joints) when prying attachment devices (such as nails or screws) from architectural members (such as deck boards) because the two paws or distal ends of the hook members are fully engaged with one or more lower support structures throughout the prying operation. The pry bar has a handle and a head, with the head having a fulcrum and two hook or paw members.

### CROSS-REFERENCE TO RELATED APPLICATIONS

This nonprovisional patent application claims priority to U.S. Provisional Application Ser. No. 62/027,530, titled PRY BAR, filed Jul. 22, 2014, which is incorporated by reference herein in its entirety.

### FIELD OF THE INVENTION

The invention relates generally to a pry bar.

### BACKGROUND AND SUMMARY OF THE INVENTION

Commercially available pry bars slip off a lower support structure (such as joints) when prying attachment devices (such as nails or screws) from architectural members (such as deck boards) because the two paws or distal ends of the hook members are not fully engaged with a lower support structure throughout the prying operation.

The present invention addresses the issue through use of a modified pry bar that includes a pair of L-shaped paw members that can be angled to address the slippage issue.

### BRIEF DESCRIPTION OF THE DRAWINGS

Embodiments of the present invention will now be described, by way of example only, with reference to the accompanying drawings for the purpose of illustrating the embodiments, and not for purposes of limiting the invention, wherein:

FIG. 1 is a front view of one embodiment of the present invention;

FIG. 2 is a left side view of the embodiment of the present invention of FIG. 1;

FIG. 3 is a right side view of a partial isometric view of the present invention of FIG. 1 illustrating the pry head;

FIG. 4 is a left side view of a partial isometric view of the present invention of FIG. 1 illustrating the pry head; and

FIG. 5 is a rear view of the pry head of the present invention of FIG. 1.

### DETAILED DESCRIPTION OF THE INVENTION

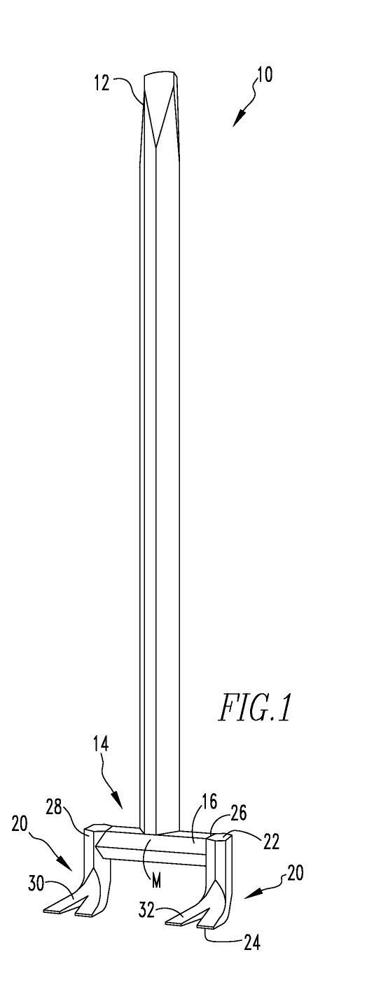

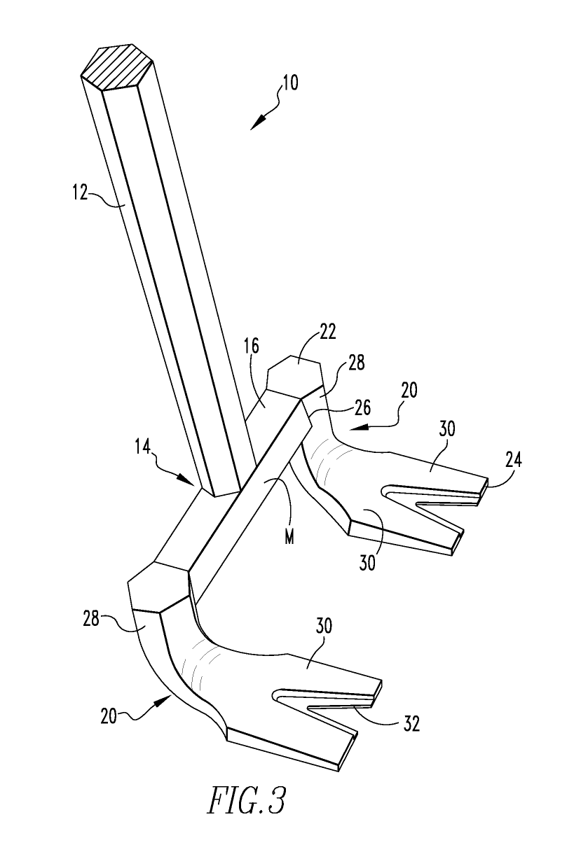

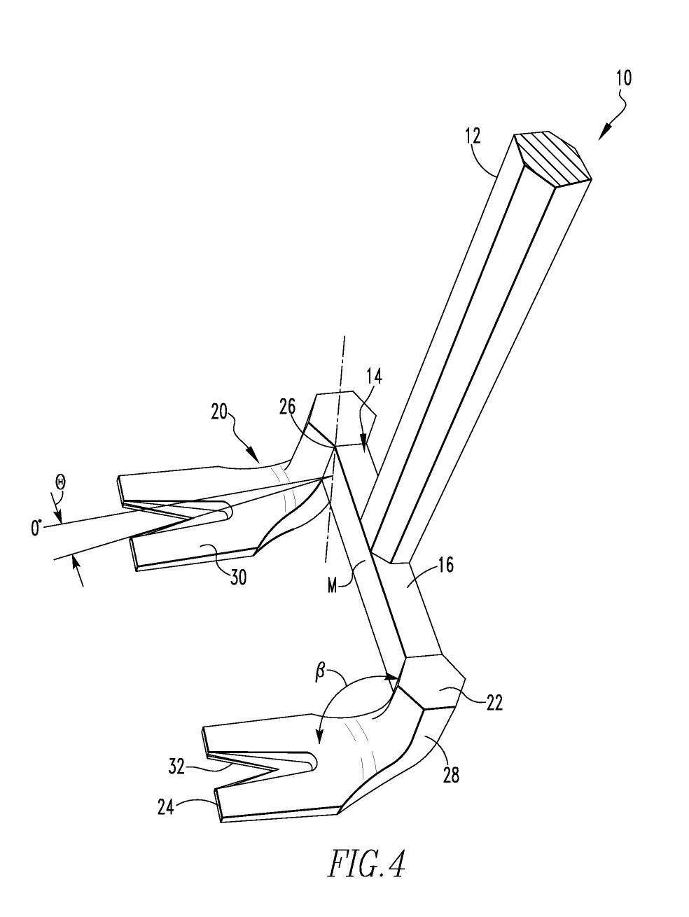

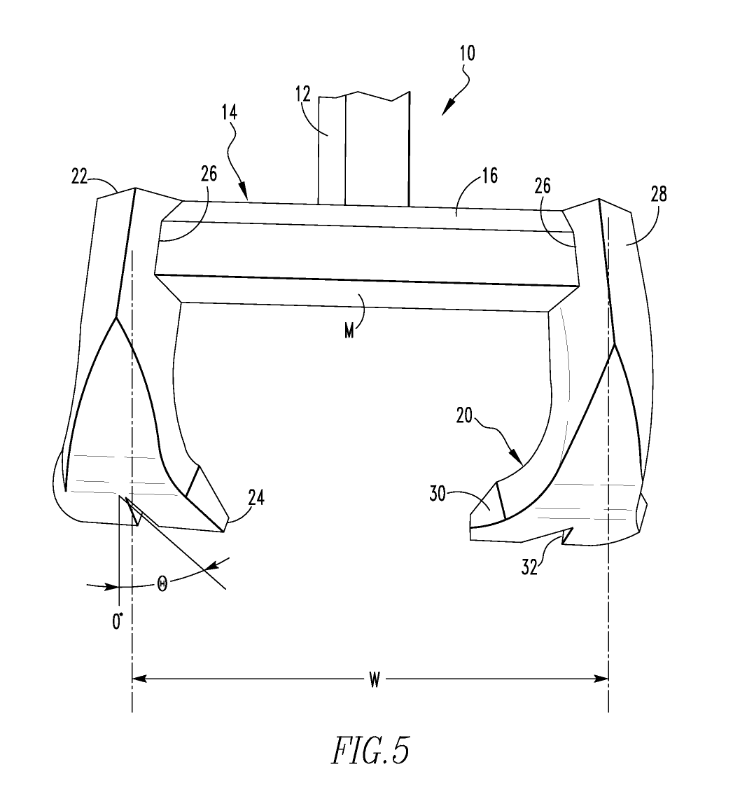

Referring now to FIGS. 1-5, in which like numerals indicate like parts, the pry bar of the present invention is shown generally at 10 for facilitating prying a flat member, such as a deck board (not shown), from slender members, such as joists (not shown).

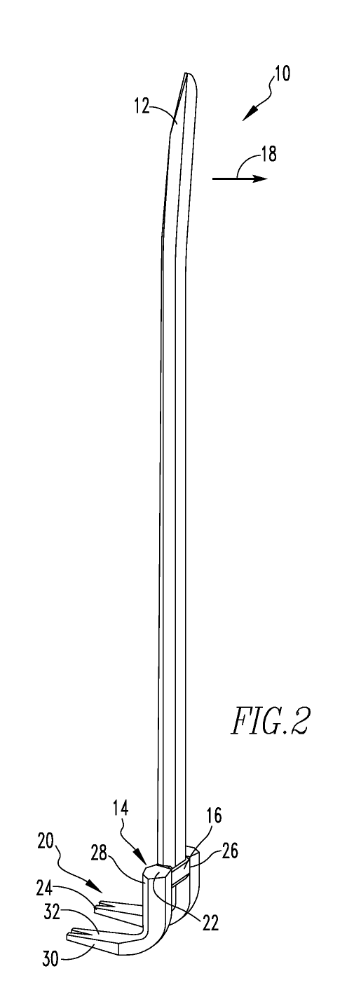

The pry bar 10 comprises a handle 12 and a head 14. The head 14 extends perpendicularly from the handle 12 at the midpoint M of the head 14. The head 14 is used for engaging under the flat member and functions as a fulcrum 16 by engaging the slender members and thereby causing the head 14 to pry the flat member from the slender members when the handle 12 is pushed away from the head 14 in a direction of arrow 18 (FIG. 2) by the fulcrum 16 pivoting on the slender member.

The head 14 comprises a fulcrum 16 and a pair of L-shaped paw members 20. The pair of L-shaped members 20 each have proximal ends 22, respectively, and distal ends 24, respectively.

The handle 12 is elongated and generally straight, for example hex steel.

The pair of generally L-shaped paw members 20 of the head 14 are formed by two sections oriented at an angle β that can range between 60 degrees to 120 degrees therewith: attachment portion 28 and prying portion 30. The width (W) between paw members 20 can range from 1.0 inches to 3.75 inches (on-center). Attachment section 28 is elongated and generally straight, for example hex steel, and together with the prying portion 30 form a paw member 20 that is generally L-shaped. Prying portion 30 is flat and generally straight including distal end 24. The distal ends 24 of the pair of L-shaped paw members 20 of the head 14 are formed into claws 32, respectively, for facilitating nail pulling and the like. Attachment portions 28 extend at proximal ends 22 perpendicular from ends 26 of fulcrum 16 and in parallel orientation with the longitudinal plane of handle 12.

The fulcrum 16 is elongated and generally straight and round, for example hex steel. The roundness in lateral cross section facilitates pivoting on the slender member. The fulcrum 16 ties the pair of L-shaped paw members 20 of the head 14 to each other, while keeping the pair of L-shaped paw members 20 of the head 14 properly spaced-apart from each other.

The distal ends 24 of the pair of prying portions 30 can be oriented towards (inward) each other, thereby forming a non-perpendicular orientation with the longitudinal plane of handle 12 denoted by angle θ. In a preferred embodiment, angle θ ranges between 0 degrees and 10 degrees, although other angles are possible. Angle θ, in one embodiment, corresponds to the orientation of the outside inner edge of claw 32, such that the outside inner edge has a perpendicular orientation to the plane of handle 12. This inward orientation of the distal ends 24 of the pair of prying portions assists the pry bar in fitting between posts or other structures (the outer edges of the prying portions 30 of the distal ends 24 do not protrude to expand the width between the outer edges). In this respect, the outer edges of the prying portions 30 of the distal ends 24 can have a predetermined distance.

The materials for the above mentioned features can be any materials suitable to withstand the operational forces, such as steel, aluminum, titanium, cast iron, brass, composites, or combinations thereof. For example, one embodiment of the present invention can be hex steel for the entire invention with machining fabrication to create certain features, such as the flat prying portion 30 with claws 32. The features can be fabricated separately as sub-components and welded together to form a monolithic structure or be extruded to form a starting structure that is monolithic.

It will be understood that each of the elements described above, or two or more together, may also find a useful application in other types of constructions differing from the types described above. While the invention has been illustrated and described as embodied in a pry bar for prying a flat member from a slender member, however, it is not limited to the details shown, since it will be understood that various omissions, modifications, substitutions and changes in the forms and details of the device illustrated and its operation can be made by those skilled in the art without departing in any way from the spirit of the present invention.

What is claimed is:

1. A pry bar comprising:
a handle, and
a head that extends perpendicularly from the handle at the midpoint of the head, the head comprising:
a fulcrum having first and second ends,
a first L-shaped paw member having a proximal end and a distal end, and being attached at the proximal end of the first paw member to the first end of the fulcrum and having a claw at the distal end of the first paw member, and
a second L-shaped paw member having a proximal end and a distal end, and being attached at the proximal end of the second paw member to the second end of the fulcrum and having a claw at the distal end of the second paw member.

2. The pry bar of claim 1, wherein the width between the first paw member and the second paw member is between about 1.0 inches and about 3.75 inches.

3. The pry bar of claim 1, wherein the distal ends 24 of the first and second L-shaped paw members are oriented inward towards, thereby forming a non-perpendicular orientation with the longitudinal plane of the handle.

4. The pry bar of claim 3, wherein the orientation between the first and second L-shaped paw members is denoted by angle θ, and angle θ ranges between 0 degrees and 10 degrees.

5. The pry bar of claim 4, wherein Angle θ corresponds to the orientation of the outside inner edge of the claw 32 in first and second L-shaped paw members, such that the outside inner edge has a perpendicular orientation to the plane of the handle.

6. The pry bar of claim 1, where the handle and head are comprised of metal.

7. The pry bar of claim 1, wherein the handle and head are comprised of hex steel.

8. The pry bar of claim 7, wherein the handle and head are fabricated separately as sub-components and welded together to form a monolithic structure.

9. The pry bar of claim 7, wherein the handle and head are extruded to form a monolithic structure.
